(19) United States
(12) Patent Application Publication
(10) Pub. No.: US 2024/0146228 A1
(43) Pub. Date: May 2, 2024

(54) MOTOR CONTROL CIRCUIT AND DISTANCE MEASUREMENT DEVICE

(71) Applicant: KABUSHIKI KAISHA TOSHIBA, Tokyo (JP)

(72) Inventors: Yosuke TOYAMA, Yokohama Kanagawa (JP); Satoshi KONDO, Kawasaki Kanagawa (JP); Tuan Thanh TA, Kawasaki Kanagawa (JP)

(73) Assignee: KABUSHIKI KAISHA TOSHIBA, Tokyo (JP)

(21) Appl. No.: 18/459,540

(22) Filed: Sep. 1, 2023

(30) Foreign Application Priority Data
Oct. 26, 2022 (JP) 2022-171632

(51) Int. Cl. H02P 27/06; H02P 21/14; H02P 21/22

(52) U.S. Cl. CPC H02P 27/06; H02P 21/14; H02P 21/22

(57) ABSTRACT

A motor control circuit has an n-phase inverter that controls a motor of n-phases (n is an integer of three or more), a current detection circuit that detects a motor current flowing through the motor of the n-phases, and a current control circuit that controls the inverter for each of a control cycle based on a command current and the motor current detected by the current detection circuit. The inverter includes transistor pairs of the n-phases provided for each phase of the motor, and the current control circuit stops, for each of the control cycle, a switching operation in at least one transistor pair of the transistor pairs of the n-phases.

### CROSS REFERENCE TO RELATED APPLICATIONS

This application is based upon and claims the benefit of priority from the prior Japanese Patent Application No. 2022-171632, filed on Oct. 26, 2022, the entire contents of which are incorporated herein by reference.

### FIELD

An embodiment of the present invention relates to a motor control circuit and a distance measurement device.

### BACKGROUND

An inverter that controls the rotation of a motor often performs pulse width modulation (PWM) control. In the PWM control, since a transistor pair in the inverter repeats on and off every switching cycle, heat due to switching loss is generated in addition to large power consumption, and it is difficult to reduce the size from the viewpoint of heat dissipation.

In order to suppress a high-frequency error component of a rotation angle of the motor, it is necessary to detect a motor current at a high speed and return the motor current. A current transformer may be used to detect the motor current. However, since the current transformer is expensive and large in size, it hinders cost reduction and downsizing.

In order to detect the motor current without using the current transformer, for example, it is conceivable to insert a resistance element into an output path of the inverter and sense a voltage between both ends of the resistance element. However, since the voltage across the resistance element greatly changes, it is necessary to provide a resistance element having a high withstand voltage.

Furthermore, it is also possible to insert a resistance element on a tail side of the inverter and detect the motor current based on the voltage across the resistance element. However, since the current flows through the resistance element only when a transistor on the tail side of the inverter is turned on, it is necessary to filter the current flowing through the resistance element. When filtering is performed, a band is narrowed, so that a high-frequency component of an error of the motor current cannot be suppressed.

### BRIEF DESCRIPTION OF THE DRAWINGS

FIG. 1 is a block diagram illustrating a schematic configuration of a motor control circuit according to a first embodiment;

FIG. 2 is a circuit diagram illustrating an example of an internal configuration of an inverter;

FIG. 3 is a block diagram of a motor control circuit that embodies an internal configuration of a current control circuit;

FIG. 4 is a waveform diagram of a motor current and a voltage waveform diagram of a control signal input to each gate of each transistor pair;

FIG. 5 is a block diagram illustrating a detailed configuration of the motor control circuit according to the first embodiment;

FIG. 6 is a circuit diagram illustrating an internal configuration of an inverter of FIG. 5;

FIG. 7 is a diagram illustrating a gate voltage waveform, a command current waveform, a motor current waveform, and an NMOS current waveform in FIG. 6;

FIG. 8 is a circuit diagram illustrating an internal configuration of an inverter according to a comparative example;

FIG. 9 is a waveform diagram of each part of FIG. 8;

FIG. 10 is a block diagram illustrating a schematic configuration of a motor control circuit according to a second embodiment;

FIG. 11 is a block diagram illustrating a detailed configuration of the motor control circuit according to the second embodiment;

FIG. 12 is a diagram illustrating a voltage waveform of a control clock signal, a gate voltage waveform, a command current waveform, a motor current waveform, and an NMOS current waveform in FIG. 11;

FIG. 13 is a block diagram illustrating a schematic configuration of a projector according to a third embodiment;

FIG. 14 is a schematic perspective view illustrating a positional relationship among a laser light source, a polygon mirror, a motor, and a motor control circuit in the projector of FIG. 13; and

FIG. 15 is a block diagram illustrating a schematic configuration of a distance measurement device including the projector of FIG. 13.

### DETAILED DESCRIPTION

According to one embodiment, a motor control circuit has an n-phase inverter that controls a motor of n-phases (n is an integer of three or more), a current detection circuit that detects a motor current flowing through the motor of the n-phases, and a current control circuit that controls the inverter for each of a control cycle based on a command current and the motor current detected by the current detection circuit. The inverter includes transistor pairs of the n-phases provided for each phase of the motor, and the current control circuit stops, for each of the control cycle, a switching operation in at least one transistor pair of the transistor pairs of the n-phases.

Hereinafter, embodiments of a motor control circuit and a distance measurement device will be described with reference to the drawings. Although main components of the motor control circuit and the distance measurement device will be mainly described below, the motor control circuit and the distance measurement device may have components and functions that are not illustrated or described. The following description does not exclude components and functions that are not illustrated or described.

### First Embodiment

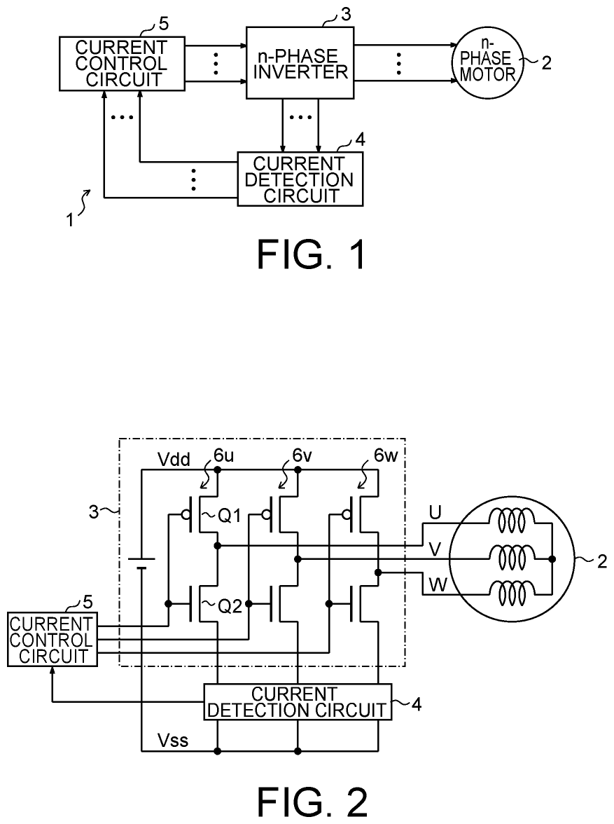

FIG. 1 is a block diagram illustrating a schematic configuration of a motor control circuit 1 according to a first embodiment. A motor control circuit 1 of FIG. 1 is a circuit that controls an n-phase (n is an arbitrary integer of three or more) motor 2, and controls a motor current flowing through each phase of the motor 2 for each control cycle. The control cycle is a cycle of a constant time length.

The motor control circuit 1 of FIG. 1 includes an inverter 3, a current detection circuit 4, and a current control circuit 5.

The inverter 3 controls the n-phase motor 2. The inverter 3 controls a motor current flowing through each phase of the motor 2 for each control cycle.

The current detection circuit 4 detects a motor current flowing through the n-phase motor 2. A specific method of detecting the motor current will be described later.

The current control circuit 5 controls the inverter 3 for each control cycle based on a command current and the motor current detected by the current detection circuit 4. The current control circuit 5 outputs a control signal for controlling the inverter 3.

FIG. 2 is a circuit diagram illustrating an example of an internal configuration of the inverter 3. Although FIG. 2 illustrates an example of the three-phase motor 2, the inverter 3 may control the motor 2 having four or more phases.

The inverter 3 includes three-phase transistor pairs 6u, 6v, and 6w provided for each phase of the motor 2. The three-phase motor 2 has a U phase, a V phase, and a W phase. The inverter 3 that controls the three-phase motor 2 includes a U-phase transistor pair 6u, a V-phase transistor pair 6v, and a W-phase transistor pair 6w.

Each of the three-phase transistor pairs 6u, 6v, and 6w includes a first transistor Q1 and a second transistor Q2 cascade-connected between a first reference voltage node (for example, a power supply voltage node) Vdd and a second reference voltage node (for example, a ground voltage node) Vss. The conductivity types of the first transistor Q1 and the second transistor Q2 are different from each other, and the first reference voltage node Vdd is a node having a higher voltage level than the second reference voltage node Vss. The first transistor Q1 and the second transistor Q2 of each of the transistor pairs 6u, 6v, and 6w are exclusively turned on or off. That is, when the first transistor Q1 of each of the transistor pairs 6u, 6v, and 6w is turned on, the second transistor Q2 is turned off, and when the first transistor Q1 is turned off, the second transistor Q2 is turned on.

In a specific example, the first transistor Q1 is a PMOS transistor, and the second transistor Q2 is an NMOS transistor. The source of the first transistor Q1 is connected to the first reference voltage node Vdd, and the drain of the first transistor Q1 is connected to the drain of the second transistor Q2. The source of the second transistor Q2 is connected to the second reference voltage node Vss. A node connecting the drain of the first transistor Q1 and the drain of the second transistor Q2 is connected to the corresponding phase of the motor 2, and the motor current flows through this node. As will be described later, a resistance element for detecting the motor current may be connected between the drain of the second transistor Q2 and the second reference voltage node Vss.

When the first transistor Q1 in the transistor pairs 6u, 6v, and 6w is turned on, the motor current flows from the first reference voltage node Vdd to the corresponding phase of the motor 2 via the first transistor Q1. When the second transistor Q2 in the transistor pairs 6u, 6v, and 6w is turned on, the motor current flows from the corresponding phase of the motor 2 to the second reference voltage node Vss through the second transistor Q2, and the motor current supplied to the corresponding phase of the motor 2 decreases.

As a result, the motor current supplied to each phase of the motor 2 increases when the first transistor Q1 of the corresponding phase is turned on, and decreases when the second transistor Q2 of the corresponding phase is turned on. In the motor 2, the rotational speed increases as the supplied motor current increases, and the rotational speed decreases as the motor current decreases. As the number of phases of the motor 2 is increased, the motor 2 can be driven with a small motor current, and the power loss can be suppressed, while the timing control of each phase becomes complicated.

The current control circuit 5 of FIG. 1 stops the switching operation of at least one transistor pair among the n-phase transistor pairs 6u, 6v, and 6w for each control cycle. In the example of FIG. 2, the current control circuit 5 turns off, for each control cycle, the first transistor Q1 in at least one transistor pair of the three-phase transistor pairs 6u, 6v, and 6w continuously during the control cycle. As a result, in each control cycle, the number of times the n first transistors Q1 included in the n-phase transistor pairs 6u, 6v, and 6w transition from off to on to off and the number of times the second transistor Q2 transitions from on to off to off can be reduced, the switching loss of the inverter 3 can be reduced, and the heat generated by the switching operation of the inverter 3 can also be suppressed, and then, the power consumption can be reduced.

The current control circuit 5 generates control signals input to the gate of the first transistor Q1 and the gate of the second transistor Q2 of each phase of the transistor pairs 6u, 6v, and 6w. The first transistor Q1 is turned on when the control signal is at a low level and turned off when the control signal is at a high level, and the second transistor Q2 is turned on when the control signal is at a high level and turned off when the control signal is at a low level. In this manner, the first transistor Q1 and the second transistor Q2 of each phase of the transistor pairs 6u, 6v, and 6w are exclusively turned on or off.

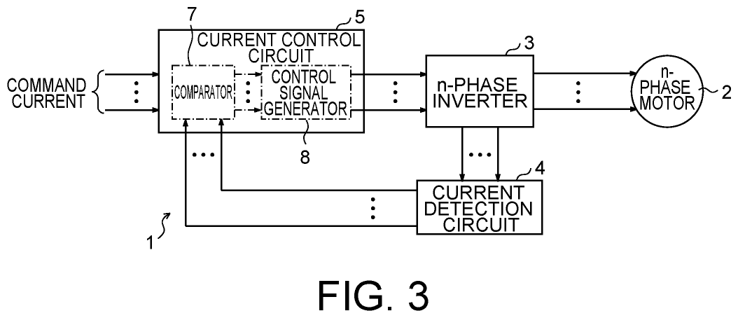

FIG. 3 is a block diagram of the motor control circuit 1 that embodies an internal configuration of the current control circuit 5. As illustrated in FIG. 3, the current control circuit 5 includes, for example, a comparator 7 and a control signal generator 8. In FIG. 3, the comparator 7 and the control signal generator 8 are illustrated one by one in the current control circuit 5, but actually, the comparators 7 and control signal generators 8 for n-phases are provided in the current control circuit 5.

The comparator 7 outputs a signal indicating whether or not the command current is larger than the motor current detected by the current detection circuit 4. For example, the comparator 7 outputs a signal of a first logic when the command current is larger than the motor current, and outputs a signal of a second logic when the command current is smaller than or equal to the motor current. The comparator 7 outputs a signal indicating whether or not the command current is larger than the motor current for each of the n-phases.

The control signal generator 8 generates a control signal for turning on one of the first transistor Q1 and the second transistor Q2 and turning off the other based on an output signal of the corresponding comparator 7 in each of the n-phase transistor pairs 6u, 6v, and 6w. For example, in each of the n-phase transistor pairs 6u, 6v, and 6w, the control signal generator 8 generates a control signal for turning on the first transistor Q1 and turning off the second transistor Q2 when the command current is larger than the motor current, and generates a control signal for turning off the first transistor Q1 and turning on the second transistor Q2 when the command current is smaller than or equal to the motor current.

As a result, in each of the n-phase transistor pairs 6u, 6v, and 6w, for each control cycle, the current control circuit 5 turns on the first transistor Q1 and causes the motor current to flow from the first reference voltage node Vdd to the corresponding phase of the motor 2 via the first transistor Q1 in a case where the comparator 7 outputs a signal indicating that the command current is larger than the motor current, and turns on the second transistor Q2 and causes the motor current to flow from the corresponding phase of the motor 2 to the second reference voltage node Vss via the second transistor Q2 in a case where the comparator 7 outputs a signal indicating that the command current is smaller than or equal to the motor current.

Furthermore, in each of the n-phase transistor pairs 6u, 6v, and 6w, in a case where the comparator 7 outputs a signal indicating that the command current is smaller than or equal to the motor current over a plurality of the consecutive control cycles, the current control circuit 5 turns off the first transistor Q1 and turns on the second transistor Q2 continuously during the plurality of consecutive control cycles. As described above, in the present embodiment, since the number of switching operations of the first transistor Q1 is minimized, the switching loss can be reduced.

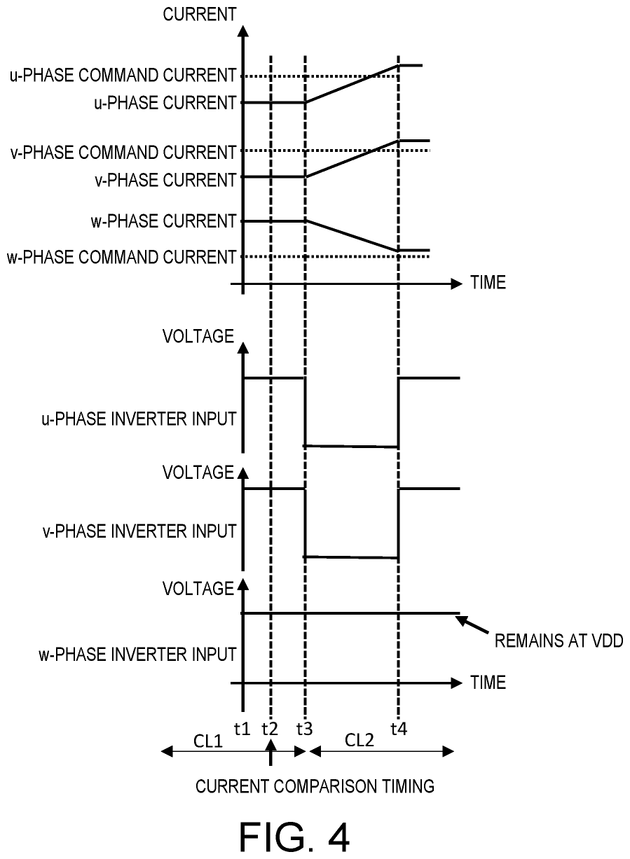

FIG. 4 is a waveform diagram of a motor current flowing through each phase of the three-phase motor 2 and a voltage waveform diagram of a control signal input to each gate of each of the transistor pairs 6u, 6v, and 6w of the three-phase motor 2. Time t1 to t3 in FIG. 4 are a part of a control cycle CL1, and time t3 to t4 are a part of another control cycle CL2. In the example of FIG. 4, from time t3 to time t4, the first transistor Q1 in the transistor pairs 6u, 6v, and 6w of the U phase and the V phase is turned on, and the first transistor Q1 in the transistor pairs 6u, 6v, and 6w of the W phase continuously maintains an off state during the control cycle CL2.

As described above, by continuously turning off the first transistor Q1 of the transistor pair 6u, 6v, or 6w of at least one phase among the three phases during the control cycle, the switching loss of the inverter 3 can be reduced to ⅔ or less, and the power consumption can be reduced.

Note that, although FIG. 4 illustrates an example in which the W-phase first transistor Q1 is continuously turned off during the control cycle CL2, the current control circuit 5 may sequentially turn off the W-phase first transistor Q1 during each control cycle.

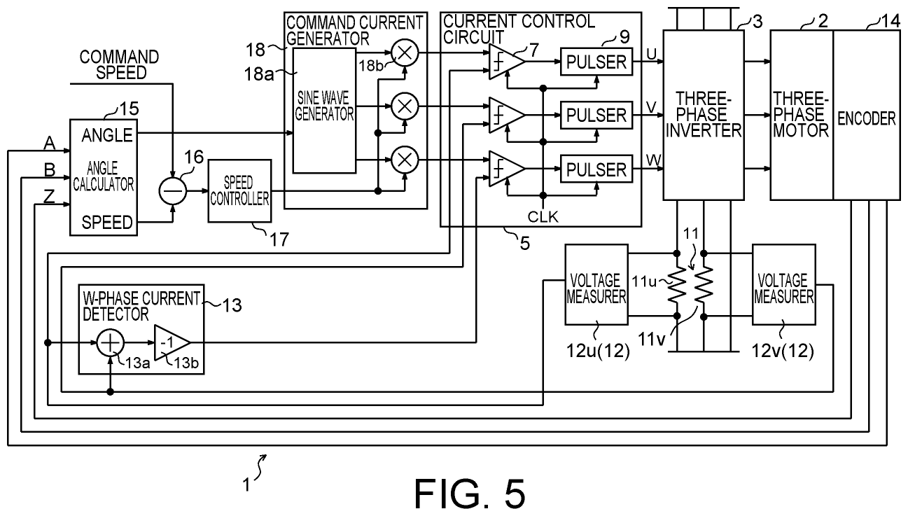

FIG. 5 is a block diagram illustrating a detailed configuration of the motor control circuit 1 according to the first embodiment. Although the motor control circuit 1 of FIG. 5 is configured to control the three-phase motor 2, it is also possible to control the motors 2 of four or more phases.

The motor control circuit 1 of FIG. 5 includes a three-phase inverter 3, a current control circuit 5, a resistance element 11, a voltage measurer 12, a W-phase current detector 13, an encoder 14, an angle calculator 15, a subtractor 16, a speed controller 17, and a command current generator 18.

The resistance element 11 includes a U-phase resistance element 11u and a V-phase resistance element 11v. The U-phase resistance element 11u is connected to a tail side of the U-phase transistor pair 6u in the inverter 3, and the V-phase resistance element 11v is connected to a tail side of the V-phase transistor pair 6v in the inverter 3. The tail side is a source side of the NMOS transistor Q2 in the inverter 3 of FIG. 2. The voltage across each of the resistance elements 11 is a value obtained by multiplying the current flowing between the drain and source of the corresponding NMOS transistor Q2 by the resistance value of the resistance element 11.

In FIG. 5, the resistance element 11 is not connected to a tail side of the W-phase transistor pair 6w. This is because the sum of the motor currents flowing to the tail sides of the three-phase transistor pairs 6u, 6v, and 6w is zero, and when the motor current flowing to the tail side of any two-phase transistor pair is known, the motor current flowing to the tail side of the remaining one-phase transistor pair can be calculated. In FIG. 5, the resistance element 11 is connected to the tail side of the transistor pairs 6u and 6v of the U phase and the V phase, but the resistance element 11 may be connected to the tail side of any two transistor pairs among the three phases.

In FIG. 5, a voltage measurer 12u that measures a voltage across the U-phase resistance element 11u and a voltage measurer 12v that measures a voltage across the V-phase resistance element 11v are provided. By measuring the voltages across the corresponding resistance elements 11u and 11v by the voltage measurers 12u and 12v, a current flowing between the drain and the source of each NMOS transistor Q2 can be detected. As described above, the voltage measurers 12u and 12v measure the voltage across the resistance element 11 to detect the motor current flowing through the tail side of the transistor pairs 6u, 6v, and 6w of the U phase and the V phase.

The W-phase current detector 13 detects a motor current flowing through the tail side of the W-phase transistor pair 6w in the inverter 3. As described above, the sum of the motor currents flowing through the transistor pairs 6u, 6v, and 6w of the U phase, the V phase, and the W phase is zero. Therefore, the W-phase current detector 13 detects the W-phase motor current by subtracting the sum of the motor currents flowing through the U-phase and V-phase transistor pairs 6u and 6v from zero.

For example, the W-phase current detector 13 includes an adder 13a and a gain block 13b. The adder 13a calculates the sum of the motor current flowing through the tail side of the U-phase transistor pair 6u and the motor current flowing through the tail side of the V-phase transistor pair 6v. The gain block 13b calculates the W-phase motor current by multiplying the motor current added by the adder 13a by −1.

The current control circuit 5 includes n-phase comparators 7 and pulsers 9 in association with the n-phase transistor pairs 6u, 6v, and 6w. The U-phase comparator 7 compares the U-phase command current output from the command current generator 18 with the motor current flowing through the tail side of the U-phase transistor pair 6u. The V-phase comparator 7 compares the V-phase command current output from the command current generator 18 with the motor current flowing through the tail side of the V-phase transistor pair 6v. The W-phase comparator 7 compares the W-phase command current output from the command current generator 18 with the motor current flowing through the tail side of the W-phase transistor pair 6w.

The comparator 7 of each phase outputs a signal indicating whether or not the command current is larger than the motor current of the corresponding phase in synchronization with a control clock signal CLK. For example, the comparator 7 of each phase outputs a signal of the first logic when the command current is larger than the motor current of the corresponding phase, and outputs a signal of the second logic when the command current is smaller than or equal to the motor current of the corresponding phase.

The pulser 9 of each phase generates a control signal corresponding to the output signal of the comparator 7 of the corresponding phase in synchronization with the control clock signal CLK. The control clock signal CLK is a signal synchronized with the control cycle. For example, in each phase pulse signal, the control signal is set to a low level when the command current of the corresponding phase is larger than the motor current, and the control signal is set to a high level when the command current of the corresponding phase is smaller than or equal to the motor current. The control signal output from the pulser 9 of each phase is input to the transistor pair 6u, 6v, or 6w of the corresponding phase of the inverter 3.

More specifically, the control signal output from the pulser 9 of each phase is input to the gates of the PMOS transistor Q1 and the NMOS transistor Q2 of the corresponding phase of the inverter 3. When the control signal is at the low level, the PMOS transistor Q1 of the corresponding transistor pair 6u, 6v, or 6w is turned on, and the NMOS transistor Q2 is turned off. As a result, the motor current flows from the first reference voltage (for example, power supply voltage) node to the corresponding phase of the motor 2 via the PMOS transistor Q1. When the control signal is at the high level, the PMOS transistor Q1 of the corresponding transistor pair 6u, 6v or 6w is turned off, and the NMOS transistor Q2 is turned on. As a result, the motor current flows from the corresponding phase of the motor 2 to the second reference voltage (for example, ground voltage) node via the second transistor Q2.

The encoder 14 is disposed in the vicinity of a rotation shaft of the motor 2, and optically detects a rotational position of the motor 2, for example. The angle calculator 15 calculates a rotation angle and a rotation speed of the motor 2 based on an output signal of the encoder 14. The subtractor 16 detects a difference between the command speed input from the outside of the motor control circuit 1 and the rotational speed of the motor 2 calculated by the angle calculator 15. The speed controller 17 generates a current amplitude signal corresponding to the difference detected by the subtractor 16.

The command current generator 18 includes a sine wave generator 18a and a multiplier 18b for n-phases. The sine wave generator 18a generates sine wave signals for n-phases based on the rotation angle calculated by the angle calculator 15. In the example of FIG. 5, the sine wave generator 18a generates sine wave signals for three phases whose phases are shifted by 120 degrees. The multiplier 18b of each phase multiplies the n-phase sine wave signals generated by the sine wave generator 18a by the current amplitude signal output from the speed controller 17 to generate the n-phase command currents. As a result, the command current generator 18 outputs the command currents for the U phase, the V phase, and the W phase.

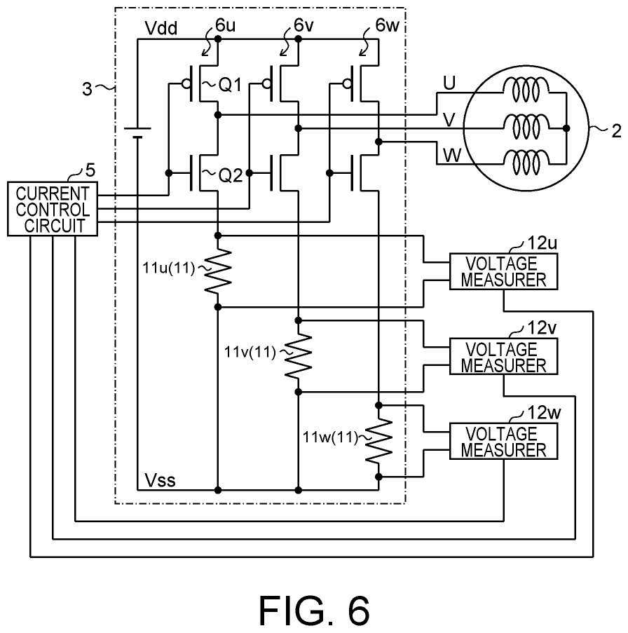

FIG. 6 is a circuit diagram illustrating an internal configuration of the inverter 3 of FIG. 5. In FIG. 6, the resistance element 11 is connected between the source of the NMOS transistor Q2 of each of the transistor pairs 6u, 6v, and 6w in the inverter 3 and the second reference voltage (ground) node. The voltage across each resistance element 11 is measured by the corresponding voltage measurer 12.

In FIG. 6, the resistance element 11w and the voltage measurer 12w are provided in association with the W-phase transistor pair 6w, but as illustrated in FIG. 5, the resistance element 11 and the voltage measurer 12 can be omitted for any one phase among the three phases.

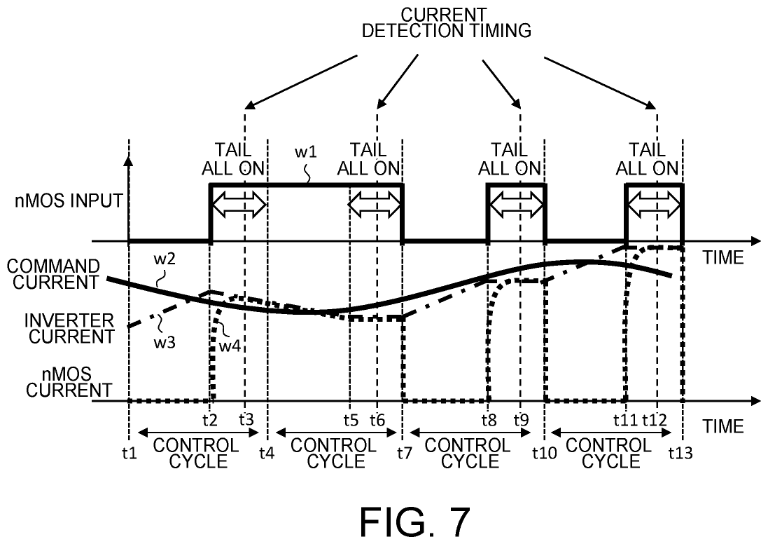

FIG. 7 is a diagram illustrating a waveform w1 of a gate voltage of the NMOS transistor Q2, a waveform w2 of the command current, a waveform w3 of the motor current (Hereinafter, also referred to as an inverter current.) flowing from the first reference voltage node Vdd of an arbitrary phase in the inverter 3 to the motor 2, and a waveform w4 of the motor current (Hereinafter, also referred to as an NMOS current.) flowing through the NMOS transistor Q2 of an arbitrary phase.

The inverter 3 switches the switching operation of the transistor pairs 6u, 6v, and 6w of the respective phases for each control cycle. Time t1 to t4, t4 to t7, t7 to t10, and t10 to t13 in FIG. 7 indicate control cycles, respectively.

The motor current (inverter current) flowing from the first reference voltage node Vdd to the motor 2 can be controlled by controlling a period in which the PMOS transistor Q1 is turned on within a period of one control cycle. More specifically, the longer the period during which the PMOS transistor Q1 is turned on within one control cycle, the more the inverter current can be increased.

The current control circuit 5 according to the present embodiment performs switching control of the transistor pairs 6u, 6v, and 6w of the respective phases based on a comparison result between the command current and the inverter current during a first period (time t1 to t2, t4 to t5, t7 to t8, t10 to t11) from the beginning of each control cycle, and turns on the NMOS transistors Q2 of all the transistor pairs 6u, 6v, and 6w during a second period (time t2 to t4, t5 to t7, t8 to t10, t11 to t13) following the first period.

The voltage measurer 12 of each phase measures, within the second period, a voltage across the resistance element 11 connected to the tail side of the transistor pairs 6u, 6v, and 6w of the corresponding phase, and detects the current flowing through the tail side. More specifically, the voltage measurer 12 of each phase measures the voltage across the resistance element 11 at times t3, t6, t9, and t12 when the NMOS transistor Q2 of each phase is turned on and the current flowing between the drain and the source of the NMOS transistor Q2 is stabilized. A period from time t2 to time t3, from time t5 to time t6, from time t8 to time t9, and from time t11 to time t12 is a setup time required for the NMOS transistor Q2 to transition from off to on and the current between the drain and the source of the NMOS transistor Q2 to be stabilized.

In the first period of each control cycle, in a case where the command current is larger than the inverter current, the PMOS transistor Q1 of the transistor pair 6u, 6v or 6w of the corresponding phase is turned on, and the inverter current increases. On the other hand, in a case where the command current is smaller than or equal to the inverter current in the first period, the NMOS transistor Q2 of the transistor pair 6u, 6v, or 6w of the corresponding phase is turned on, and the inverter current decreases (the NMOS current increases).

As described above, in the present embodiment, the second period in which the NMOS transistor Q2 of each phase transistor pair 6u, 6v or 6w is forcibly turned on is provided for each control cycle, and the current flowing through the tail side of each phase transistor pair 6u, 6v, or 6w in the second period is measured by the voltage measurer 12. Since the voltage measurer 12 measures the voltage across the resistance element 11 after the current flowing between the drain and source of the NMOS transistor Q2 is stabilized, there is no risk of being affected by noise.

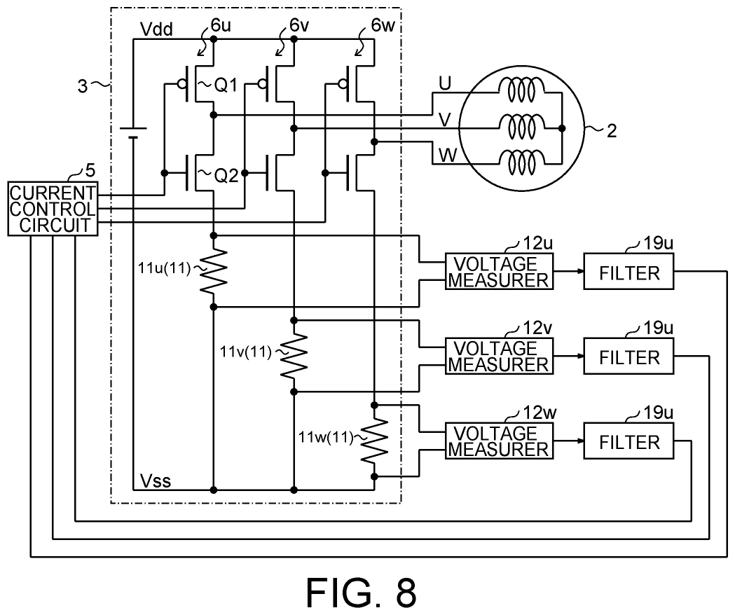

FIG. 8 is a circuit diagram illustrating an internal configuration of an inverter 3 according to a comparative example. In FIG. 8, the same components as those in FIG. 6 are denoted by the same reference signs, and differences will be mainly described below. In FIG. 8, filters 19u, 19v, and 19w are connected to rear stage sides of voltage measurers 12u, 12v, and 12w that measure voltages across resistance elements 11 connected to tail sides of transistor pairs 6u, 6v, and 6w of the respective phases. The currents output from the voltage measurers 12u, 12v, and 12w are filtered by the filters 19u, 19v, and 19w, and then input to the current control circuit 5.

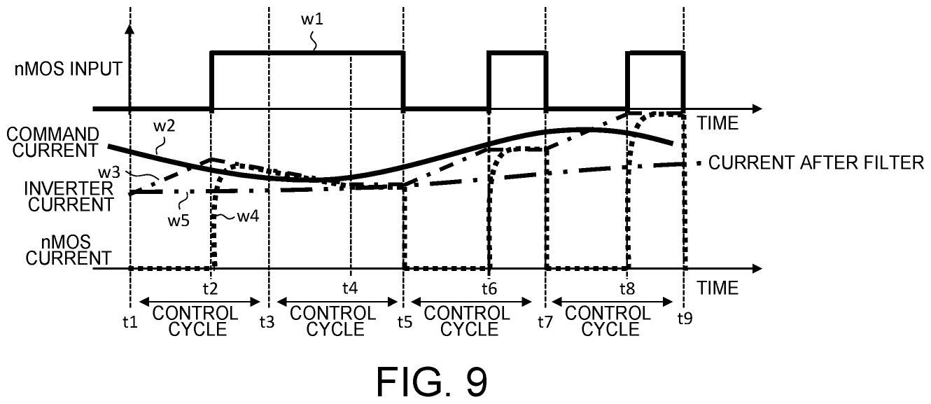

FIG. 9 is a waveform diagram of each part of FIG. 8. Similarly to FIG. 7, FIG. 9 illustrates a waveform w1 of the gate voltage of the NMOS transistor Q2, a waveform w2 of the command current, a waveform w3 of the inverter current, and a waveform w4 of the drain-source current of the NMOS transistor Q2.

In FIG. 9, a timing of measuring an end-to-end voltage of the resistance element 11 on the tail side of the transistor pair 6u, 6v, or 6w of each phase is not determined. Since a current does not flow between the drain and the source of the NMOS transistor Q2 only when the NMOS transistor Q2 is on, it is necessary to provide the filters 19u, 19v, and 19w, average the drain-source current of the NMOS transistor Q2, and then measure the voltage across the resistance element 11 as illustrated in the waveform w5. For this reason, the current flowing through the tail side of the transistor pair 6u, 6v, or 6w of each phase cannot be accurately detected, and a high-frequency error component between the command current and the inverter current cannot be suppressed.

On the other hand, in the present embodiment, the voltage across both ends of the resistance element 11 is measured after the NMOS transistor Q2 of each phase is forcibly turned on in the second period in the control cycle for each control cycle, so that the current flowing through the tail side of the transistor pair 6u, 6v, or 6w of each phase can be accurately detected for each control cycle.

As described above, in the first embodiment, the resistance element 11 is connected to the tail side of the transistor pair 6u, 6v, or 6w of each phase in the inverter 3, the second period in which the NMOS transistor Q2 of each transistor pair 6u, 6v, or 6w is forcibly turned on is provided for each control cycle, and the voltage across both ends of the resistance element 11 is measured within the second period. Therefore, the motor current can be accurately detected with a simple configuration without providing a current transformer, a filter, and the like, and the motor control circuit 1 can be downsized.

Furthermore, in the first embodiment, since the PMOS transistor Q1 of at least one phase transistor pair 6u, 6v, or 6w of the n-phase transistor pairs 6u, 6v, and 6w is continuously turned off during the control cycle, the number of switching operations of the transistor pairs 6u, 6v, and 6w of the respective phases can be reduced, the switching loss of the inverter 3 can be suppressed, and the power consumption can be reduced.

Moreover, in the first embodiment, the command current and the motor current are compared, and the PMOS transistor Q1 of the transistor pair 6u, 6v, and 6w is turned on only when the command current is larger than the motor current. Therefore, the number of switching times of the transistor pair 6u, 6v, or 6w of each phase can be reduced, and the switching loss can be suppressed and the power consumption can be reduced.

### Second Embodiment

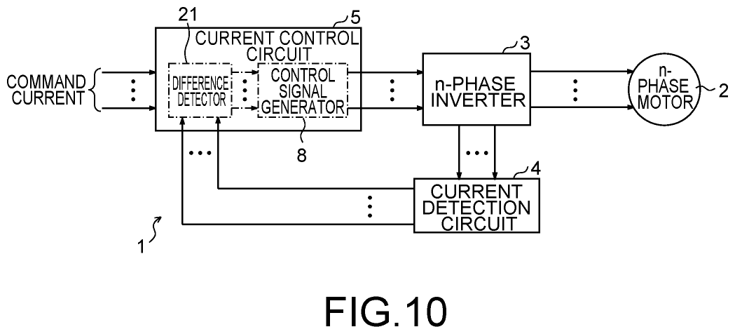

FIG. 10 is a block diagram illustrating a schematic configuration of a motor control circuit 1 according to a second embodiment. In FIG. 10, the same components as those in FIG. 3 are denoted by the same reference signs, and differences will be mainly described below.

A motor control circuit 1 of FIG. 10 includes a current control circuit 5 having a configuration different from that of the motor control circuit 1 of FIG. 3. The current control circuit 5 of FIG. 10 includes a difference detector 21 and a control signal generator 8.

The difference detector 21 detects a difference between the command current and the motor current for each of the n-phases. In FIG. 3, the comparator 7 is provided instead of the difference detector 21. The comparator 7 in FIG. 3 outputs a binary signal indicating whether or not the command current is larger than the motor current, whereas the difference detector 21 in FIG. 10 outputs a signal corresponding to a magnitude of the difference between the command current and the motor current. For example, the difference detector 21 outputs signals having different signal amplitudes according to the magnitude of the difference.

The control signal generator 8 generates a control signal having a pulse width proportional to the difference detected by the difference detector 21. For example, the control signal generator 8 generates a control signal having a larger pulse width as the difference detected by the difference detector 21 is larger.

The control signal output from the control signal generator 8 is input to the gates of the transistor pairs 6u, 6v, and 6w of the respective phases in the inverter 3. For example, the control signal generator 8 increases a negative pulse width of the control signal as the difference between the command current and the motor current increases. The transistor pair 6u, 6v, or 6w of each phase in the inverter 3 turns on the PMOS transistor Q1 and turns on the NMOS transistor Q2 within a period of the negative pulse width of the corresponding control signal. Therefore, as the negative pulse width of the control signal increases, the motor current (inverter current) flowing from the first reference voltage node Vdd to the motor 2 increases. This increases the rotational speed of the motor 2.

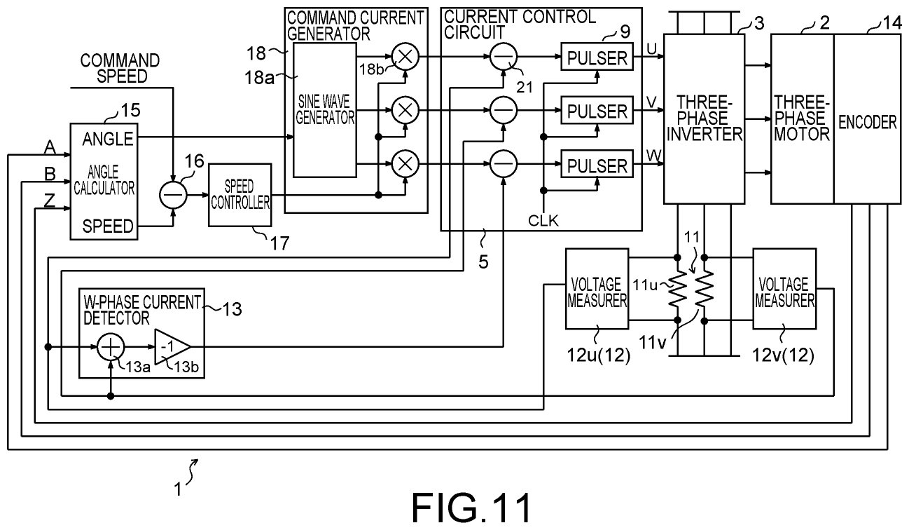

FIG. 11 is a block diagram illustrating a detailed configuration of the motor control circuit 1 according to the second embodiment. In FIG. 11, the same components as those in FIG. 5 are denoted by the same reference signs, and differences will be mainly described below.

The motor control circuit 1 of FIG. 11 is different from the motor control circuit 1 of FIG. 5 in the internal configuration of the current control circuit 5. The current control circuit 5 of FIG. 11 includes a difference detector 21 and a pulser 9 for each of the n-phases. The difference detector 21 detects a difference between the command current of the corresponding phase and the motor current of the corresponding phase. The pulser 9 generates a control signal having a pulse width corresponding to the magnitude of the difference between the corresponding phases. The control signal output from the pulser 9 of each phase is input to the gates of the transistor pairs 6u, 6v, and 6w of the corresponding phases.

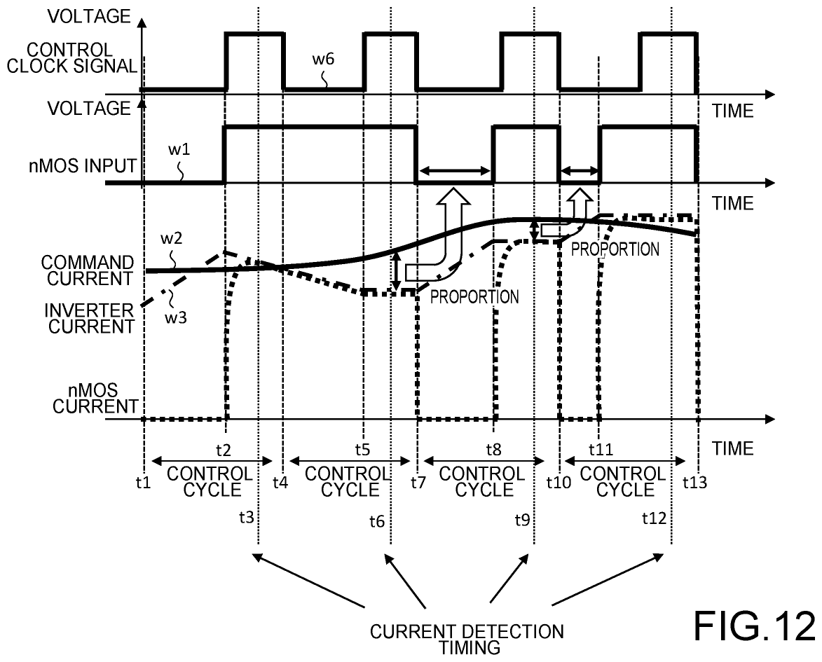

FIG. 12 is a diagram illustrating a voltage waveform w6 of a control clock signal CLK, a waveform w1 of a gate voltage of the NMOS transistor Q2 in the motor control circuit 1 of FIG. 11, a waveform w2 of the command current, a waveform w3 of the motor current (inverter current) flowing from the first reference voltage node Vdd of an arbitrary phase in the inverter 3 to the motor 2, and a waveform w4 of the motor current (NMOS current) flowing through the NMOS transistor Q2 of an arbitrary phase.

Also in FIG. 12, the NMOS transistors Q2 of all the phases are forcibly turned on in the second period in each control cycle, and at times t3, t6, t9, and t12 when the drain-source current of the NMOS transistor Q2 is stabilized, the voltage measurer 12 measures the voltage across the resistance element 11, and detects the current flowing through the tail side of each of the transistor pairs 6u, 6v, and 6w.

At time t6, the current control circuit 5 detects that the command current is larger than the inverter current, and generates a control signal having a pulse width (times t7 to t8) according to a difference between the command current and the inverter current. As a result, during the period from time t7 to time t8, the PMOS transistor Q1 is turned on, and the inverter current increases.

Thereafter, at time t9 which is the next current detection timing, the difference between the command current detected by the current control circuit 5 and the inverter current is smaller than that at time t6. Therefore, a length of the period during which the PMOS transistor Q1 is turned on between times t10 and t11 is shorter than between times t7 and t8.

As described above, in the second embodiment, the length of the period during which the PMOS transistor Q1 of the corresponding transistor pair 6u, 6v, or 6w is turned on is changed according to the magnitude of the difference between the command current and the inverter current. As a result, the inverter current can be made to match the command current more quickly. Furthermore, also in the second embodiment, similarly to the first embodiment, the NMOS transistors Q2 of all the phases are forcibly turned on in a partial period (second period) in each control cycle, and the current flowing through the tail side of each of the transistor pairs 6u, 6v, and 6w is detected. Therefore, the current flowing through the inverter 3 can be accurately detected with a simple configuration, and the n-phase motor 2 can be efficiently driven.

### Third Embodiment

In the third embodiment, the motor control circuit 1 according to the first or second embodiment is applied to a scanning unit that scans a light pulse signal emitted from a light emitting unit for a distance measurement device.

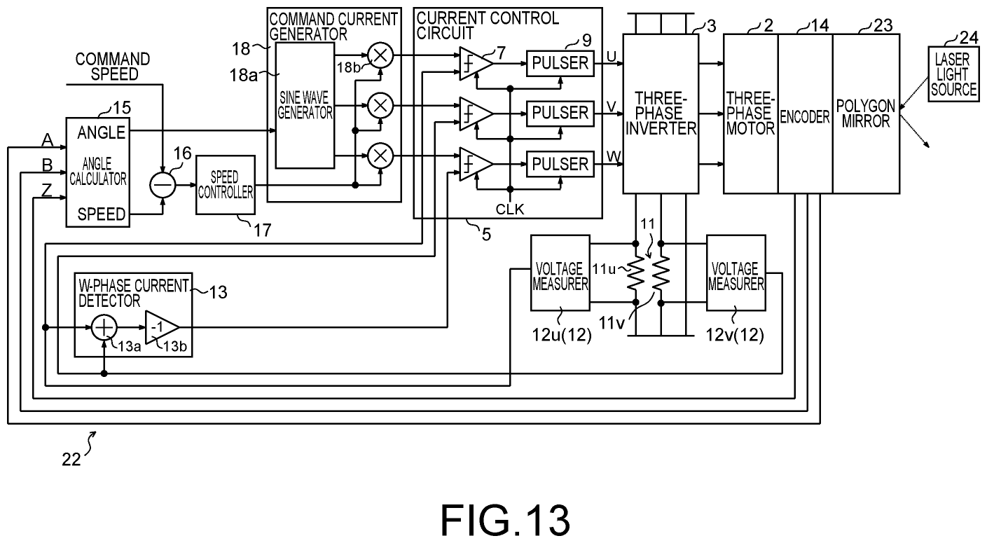

FIG. 13 is a block diagram illustrating a schematic configuration of a light projector 22 according to a third embodiment. A light projector 22 in FIG. 13 includes the motor control circuit 1 according to the first or second embodiment, a motor 2, a polygon mirror 23, and a laser light source 24. The motor control circuit 1 of FIG. 13 has the same configuration as that of FIG. 1, but may have the same configuration as that of FIG. 11.

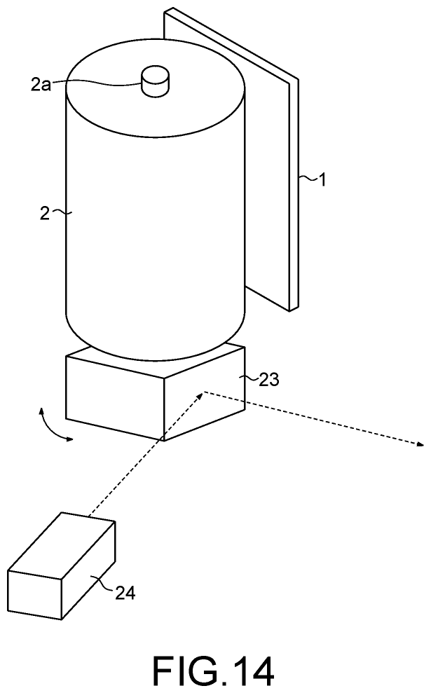

FIG. 14 is a schematic perspective view illustrating a positional relationship among the laser light source 24, the polygon mirror 23, the motor 2, and the motor control circuit 1 in the light projector 22 of FIG. 13. The polygon mirror 23 is rotatably attached to a rotation shaft 2a of the motor 2. A mirror surface of the polygon mirror 23 is irradiated with a light pulse signal from the laser light source 24. A direction of the mirror surface of the polygon mirror 23 changes as needed according to the rotation of the rotation shaft 2a, and the light pulse signal is scanned in a one-dimensional direction or a two-dimensional direction. By adjusting the rotational speed of the motor 2, the scanning speed of the light pulse signal can be variably controlled.

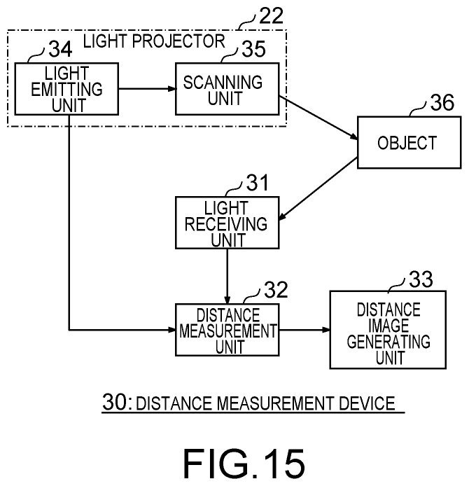

FIG. 15 is a block diagram illustrating a schematic configuration of a distance measurement device 30 including the light projector 22 of FIG. 13. A distance measurement device 30 in FIG. 15 is a device that performs distance measurement by a direct time of flight (dToF) method, and is also referred to as a light detecting and ranging (LiDAR) device. The distance measurement device 30 in FIG. 15 includes the light projector 22, a light receiving unit 31, a distance measurement unit 32, and a distance image generating unit 33.

The light projector 22 is configured similarly to FIGS. 13 and 14, and includes a light emitting unit 34 including the laser light source 24, and a scanning unit 35 including the polygon mirror 23, the motor 2, and the motor control circuit 1.

The light receiving unit 31 receives a reflected light pulse signal obtained by reflecting the light pulse signal projected from the light projector 22 by an object 36. The light receiving unit 31 includes an avalanche photo diode (APD), a single photon avalanche diode (SPAD), or the like.

The distance measurement unit 32 measures a distance of the object 36 on the basis of a time difference between a timing at which the light emitting unit emits the light pulse signal and a timing at which the light receiving unit 31 receives the reflected light pulse signal.

The distance image generating unit 33 generates a distance image in which a color or gradation is changed according to the distance on the basis of the distance of the object 36 repeatedly measured by the distance measurement unit 32.

The motor control circuit 1 according to the first or second embodiment can accurately control the rotation of the motor 2 while being downsized, and thus can accurately scan the light pulse signal. Therefore, the distance of the object 36 can be accurately detected.

Furthermore, in a case where the same position is irradiated with light from a plurality of the light projectors 22 in order to measure the distance of the object 36 located at a long distance, it is necessary to control a light emission direction of light from each of the light projectors 22 with high accuracy. However, since the motor control circuit 1 according to the first or second embodiment can control the rotation of the polygon mirror 23 with high accuracy, the light can be accurately emitted from the plurality of light projectors 22 toward the same position.

The above-described embodiments may be configured as follows.
(1) A motor control circuit comprising:
an n-phase inverter that controls a motor of n-phases (n is an integer of three or more);
a current detection circuit that detects a motor current flowing through the motor of the n-phases; and
a current control circuit that controls the inverter for each of a control cycle based on a command current and the motor current detected by the current detection circuit, wherein
the inverter includes transistor pairs of the n-phases provided for each phase of the motor, and
the current control circuit stops, for each of the control cycle, a switching operation in at least one transistor pair of the transistor pairs of the n-phases.
(2) The motor control circuit according to (1), wherein
each of the transistor pairs of the n-phases includes:
a first transistor that switches whether or not to cause the motor current to flow from a first reference voltage node to a corresponding phase of the motor; and
a second transistor that switches whether or not to cause the motor current to flow from a corresponding phase of the motor to a second reference voltage node, and
the current control circuit continuously turns off, for each of the control cycle, the first transistor in at least one transistor pair of the transistor pairs of the n-phases during the control cycle.
(3) The motor control circuit according to (2), wherein
the current control circuit sequentially switches, for each of the control cycle, a type of the transistor pair including the first transistor that is continuously turned off during the control cycle.
(4) The motor control circuit according to (2) or (3), wherein
in each of the transistor pairs of the n-phases, the current control circuit turns on, for each of the control cycle, one of the first transistor and the second transistor and turns off another based on the command current and the motor current detected by the current detection circuit.
(5) The motor control circuit according to (2) or (3), wherein
the current control circuit includes:
a comparator that outputs, for each of the n-phases, a signal indicating whether or not the command current is larger than the motor current detected by the current detection circuit; and
a control signal generator that generates a control signal for turning on one of the first transistor and the second transistor and turning off another based on an output signal of the comparator in each of the transistor pairs of the n-phases.
(6) The motor control circuit according to (5), wherein
in each of the transistor pairs of the n-phases, for each of the control cycle, the current control circuit turns on the first transistor and causes the motor current to flow from the first reference voltage node to the corresponding phase of the motor via the first transistor in a case where the comparator outputs a signal indicating that the command current is larger than the motor current, and turns on the second transistor and causes the motor current to flow from the corresponding phase of the motor to the second reference voltage node via the second transistor in a case where the comparator outputs a signal indicating that the command current is less than or equal to the motor current.
(7) The motor control circuit according to (6), wherein
in a case where the comparator outputs a signal indicating that the command current is less than or equal to the motor current over a plurality of the consecutive control cycles, the current control circuit turns off the first transistor and turns on the second transistor continuously during the plurality of consecutive control cycles in each of the transistor pairs of the n-phases.
(8) The motor control circuit according to any one of (2) to (4), wherein
the current control circuit detects a difference between the command current and the motor current detected by the current detection circuit for each of the n-phases, and turns on one of the first transistor and the second transistor and turns off another within a period of a time length corresponding to the difference for each of the control cycle.
(9) The motor control circuit according to (8),
the current control circuit turns on, for each of the control cycle,
the first transistor for a period proportional to the difference in each of the transistor pairs of the n-phases.
(10) The motor control circuit according to (8) or (9),
the current control circuit includes:
a difference detector that detects, for each of the n-phases, a difference between the command current and the motor current detected by the current detection circuit; and
a control signal generator that generates, for each of the n-phases, a control signal having a pulse width proportional to the difference, and
each of the transistor pairs of the n-phases turns on one of the first transistor and the second transistor and turns off the other based on the corresponding control signal.
(11) The motor control circuit according to (10), wherein
in a case where the difference detector detects that the command current is less than or equal to the motor current, the current control circuit continuously turns off the first transistor and turns on the second transistor during a plurality of the consecutive control cycles in each of the transistor pairs of the n-phases.
(12) The motor control circuit according to any one of (2) to (11), wherein
the current control circuit turns on, for each of the control cycle, all of the second transistors in the transistor pairs of the n-phases in a partial period of the control cycle, and
the current detection circuit detects the motor current within the partial period.
(13) The motor control circuit according to (12), wherein
the control cycle includes a first period and a second period following the first period, and
in each of the transistor pairs of the n-phases, for each of the control cycle, the current control circuit turns on one of the first transistor and the second transistor and turns off another in the first period based on the command current and the motor current detected by the current detection circuit, and turns on all of the second transistors in the transistor pairs of the n-phases in the second period.
(14) The motor control circuit according to (13), wherein
the current detection circuit detects the motor current at a timing when a current flowing from the corresponding phase of the motor to the second reference voltage node via the second transistors is stable within the second period.
(15) The motor control circuit according to any one of (1) to (14), further comprising:
a rotation speed detector that detects a rotation speed of the motor; and
a command current generator that generates the command current based on a command speed and the rotation speed detected by the rotation speed detector.
(16) A distance measurement device comprising:
a light emitter that emits a light pulse signal;
a scanner that scans the light pulse signal in a one-dimensional direction or a two-dimensional direction;
a light receiver that receives a reflected light pulse signal obtained by reflecting the light pulse signal by an object; and
a distance measurer that measures a distance of the object based on the light pulse signal and the reflected light pulse signal, wherein
the scanner includes
a reflecting member that reflects the light pulse signal,
a motor that rotates the reflecting member, and
a motor control circuit that controls rotation of the motor,
the motor control circuit includes
an n-phase inverter that controls the motor of n-phases (n is an integer of three or more),
a current detection circuit that detects a motor current flowing through the motor of the n-phases; and
a current control circuit that controls the inverter for each of a control cycle based on a command current and the motor current detected by the current detection circuit,
the inverter includes transistor pairs of the n-phases provided for each phase of the motor, and
the current control circuit performs, for each of the control cycle, control such that the motor current does not flow from at least one phase transistor pair of the transistor pairs of the n-phases to the motor.
(17) The distance measurement device according to (16), wherein
each of the transistor pairs of the n-phases includes:
a first transistor that switches whether or not to cause the motor current to flow from a first reference voltage node to a corresponding phase of the motor; and
a second transistor that switches whether or not to cause the motor current to flow from a corresponding phase of the motor to a second reference voltage node, and
the current control circuit continuously turns off, for each of the control cycle, the first transistor in at least one transistor pair of the transistor pairs of the n-phases during the control cycle.
(18) The distance measurement device according to (17), wherein
the current control circuit sequentially switches, for each of the control cycle, a type of the transistor pair including the first transistor that is continuously turned off during the control cycle.
(19) The distance measurement device according to (17) or (18), wherein
in each of the transistor pairs of the n-phases, the current control circuit turns on, for each of the control cycle, one of the first transistor and the second transistor and turns off another based on the command current and the motor current detected by the current detection circuit.
(20) The distance measurement device according to (17) or (18), wherein
the current control circuit includes:
a comparator that outputs, for each of the n-phases, a signal indicating whether or not the command current is larger than the motor current detected by the current detection circuit; and
a control signal generator that generates a control signal for turning on one of the first transistor and the second transistor and turning off another based on an output signal of the comparator in each of the transistor pairs of the n-phases.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

1. A motor control circuit comprising:
an n-phase inverter that controls a motor of n-phases (n is an integer of three or more);
a current detection circuit that detects a motor current flowing through the motor of the n-phases; and
a current control circuit that controls the inverter for each of a control cycle based on a command current and the motor current detected by the current detection circuit, wherein
the inverter includes transistor pairs of the n-phases provided for each phase of the motor, and
the current control circuit stops, for each of the control cycle, a switching operation in at least one transistor pair of the transistor pairs of the n-phases.

2. The motor control circuit according to claim 1, wherein
each of the transistor pairs of the n-phases includes:
a first transistor that switches whether or not to cause the motor current to flow from a first reference voltage node to a corresponding phase of the motor; and
a second transistor that switches whether or not to cause the motor current to flow from a corresponding phase of the motor to a second reference voltage node, and
the current control circuit continuously turns off, for each of the control cycle, the first transistor in at least one transistor pair of the transistor pairs of the n-phases during the control cycle.

3. The motor control circuit according to claim 2, wherein
the current control circuit sequentially switches, for each of the control cycle, a type of the transistor pair including the first transistor that is continuously turned off during the control cycle.

4. The motor control circuit according to claim 2, wherein
in each of the transistor pairs of the n-phases, the current control circuit turns on, for each of the control cycle, one of the first transistor and the second transistor and turns off another based on the command current and the motor current detected by the current detection circuit.

5. The motor control circuit according to claim 2, wherein
the current control circuit includes:
a comparator that outputs, for each of the n-phases, a signal indicating whether or not the command current is larger than the motor current detected by the current detection circuit; and
a control signal generator that generates a control signal for turning on one of the first transistor and the second transistor and turning off another based on an output signal of the comparator in each of the transistor pairs of the n-phases.

6. The motor control circuit according to claim 5, wherein
in each of the transistor pairs of the n-phases, for each of the control cycle, the current control circuit turns on the first transistor and causes the motor current to flow from the first reference voltage node to the corresponding phase of the motor via the first transistor in a case where the comparator outputs a signal indicating that the command current is larger than the motor current, and turns on the second transistor and causes the motor current to flow from the corresponding phase of the motor to the second reference voltage node via the second transistor in a case where the comparator outputs a signal indicating that the command current is less than or equal to the motor current.

7. The motor control circuit according to claim 6, wherein
in a case where the comparator outputs a signal indicating that the command current is less than or equal to the motor current over a plurality of the consecutive control cycles, the current control circuit turns off the first transistor and turns on the second transistor continuously during the plurality of consecutive control cycles in each of the transistor pairs of the n-phases.

8. The motor control circuit according to claim 2, wherein
the current control circuit detects a difference between the command current and the motor current detected by the current detection circuit for each of the n-phases, and turns on one of the first transistor and the second transistor and turns off another within a period of a time length corresponding to the difference for each of the control cycle.

9. The motor control circuit according to claim 8,
the current control circuit turns on, for each of the control cycle, the first transistor for a period proportional to the difference in each of the transistor pairs of the n-phases.

10. The motor control circuit according to claim 8,
the current control circuit includes:
a difference detector that detects, for each of the n-phases, a difference between the command current and the motor current detected by the current detection circuit; and
a control signal generator that generates, for each of the n-phases, a control signal having a pulse width proportional to the difference, and
each of the transistor pairs of the n-phases turns on one of the first transistor and the second transistor and turns off the other based on the corresponding control signal.

11. The motor control circuit according to claim 10, wherein
in a case where the difference detector detects that the command current is less than or equal to the motor current, the current control circuit continuously turns off the first transistor and turns on the second transistor during a plurality of the consecutive control cycles in each of the transistor pairs of the n-phases.

12. The motor control circuit according to claim 2, wherein
the current control circuit turns on, for each of the control cycle, all of the second transistors in the transistor pairs of the n-phases in a partial period of the control cycle, and
the current detection circuit detects the motor current within the partial period.

13. The motor control circuit according to claim 12, wherein
the control cycle includes a first period and a second period following the first period, and
in each of the transistor pairs of the n-phases, for each of the control cycle, the current control circuit turns on one of the first transistor and the second transistor and turns off another in the first period based on the command current and the motor current detected by the current detection circuit, and turns on all of the second transistors in the transistor pairs of the n-phases in the second period.

14. The motor control circuit according to claim 13, wherein
the current detection circuit detects the motor current at a timing when a current flowing from the corresponding phase of the motor to the second reference voltage node via the second transistors is stable within the second period.

15. The motor control circuit according to claim 1, further comprising:
a rotation speed detector that detects a rotation speed of the motor; and
a command current generator that generates the command current based on a command speed and the rotation speed detected by the rotation speed detector.

16. A distance measurement device comprising:
a light emitter that emits a light pulse signal;
a scanner that scans the light pulse signal in a one-dimensional direction or a two-dimensional direction;
a light receiver that receives a reflected light pulse signal obtained by reflecting the light pulse signal by an object; and
a distance measurer that measures a distance of the object based on the light pulse signal and the reflected light pulse signal, wherein
the scanner includes
a reflecting member that reflects the light pulse signal,
a motor that rotates the reflecting member, and
a motor control circuit that controls rotation of the motor,
the motor control circuit includes
an n-phase inverter that controls the motor of n-phases (n is an integer of three or more),
a current detection circuit that detects a motor current flowing through the motor of the n-phases; and
a current control circuit that controls the inverter for each of a control cycle based on a command current and the motor current detected by the current detection circuit,
the inverter includes transistor pairs of the n-phases provided for each phase of the motor, and
the current control circuit performs, for each of the control cycle, control such that the motor current does not flow from at least one phase transistor pair of the transistor pairs of the n-phases to the motor.

17. The distance measurement device according to claim 16, wherein
each of the transistor pairs of the n-phases includes:
a first transistor that switches whether or not to cause the motor current to flow from a first reference voltage node to a corresponding phase of the motor; and
a second transistor that switches whether or not to cause the motor current to flow from a corresponding phase of the motor to a second reference voltage node, and
the current control circuit continuously turns off, for each of the control cycle, the first transistor in at least one transistor pair of the transistor pairs of the n-phases during the control cycle.

18. The distance measurement device according to claim 17, wherein
the current control circuit sequentially switches, for each of the control cycle, a type of the transistor pair including the first transistor that is continuously turned off during the control cycle.

19. The distance measurement device according to claim 17, wherein
in each of the transistor pairs of the n-phases, the current control circuit turns on, for each of the control cycle, one of the first transistor and the second transistor and turns off another based on the command current and the motor current detected by the current detection circuit.

20. The distance measurement device according to claim 17, wherein
the current control circuit includes:
a comparator that outputs, for each of the n-phases, a signal indicating whether or not the command current is larger than the motor current detected by the current detection circuit; and
a control signal generator that generates a control signal for turning on one of the first transistor and the second transistor and turning off another based on an output signal of the comparator in each of the transistor pairs of the n-phases.
